(19) United States
(12) Patent Application Publication
(10) Pub. No.: US 2004/0118989 A1
(43) Pub. Date: Jun. 24, 2004

(54) Lightweight, portable holding device

(76) Inventor: Leslie Sidelman, Oceanside, NY (US)

Correspondence Address: R. Lewis Gable, Cowan, Liebowitz & Latman, P.C., 1133 Avenue of the Americas, New York, NY, 10036, US

(21) Appl. No.: 10/682,469

(22) Filed: Oct. 9, 2003

Related U.S. Application Data
(60) Provisional application No. 60/426,110, filed on Nov. 14, 2002.

(51) Int. Cl. B42F 13/00

(52) U.S. Cl. 248/339; 248/914

(57) ABSTRACT

There is described a device for suspending an object from the surface of a support, that comprises a first leg adapted to abut the support surface, and a second leg being connected to the first leg so that the first leg is oriented at an angle with respect to the second leg. A hook is connected to the first leg and is adapted to be releasably attached to the object and, when the first leg is disposed on the support surface, the hook lies beneath the first leg, so that the weight of the object exerts a force on the first leg toward the support surface.

### RELATED APPLICATIONS

This non-provisional application is related to and depends for priority from U.S. Provisional Application No. 60/426,110, filed Nov. 14, 2002 in the name of Leslie Sidelman, entitled “LIGHTWEIGHT, PORTABLE HOLDING DEVICE”, and incorporated herein by reference.

### FIELD OF THE INVENTION

This invention relates to apparatus or devices for suspending objects such as hand bags, brief cases and the like from horizontally oriented surfaces such as a surface of a dining table, a desk or the like.

### BACKGROUND OF THE INVENTION

It is well-known to provide a handbag or purse holder for use by the user or owner of such when they sit down at a table or desk. In this Background of the Invention section, there is listed a number of references, which describe various devices devised for such application and use. The rationale of such devices is that first, in many instances, there may not be sufficient space on a table or desk at which the owner sits (perhaps with several others, each also with a purse) to put or set the purse or handbag on the table or desk surface. This may be from the small size of the table or desk surface, or the fact that the surface thereof is already well covered with materials and articles or both. Secondly, the owner or user of the purse or handbag does not want to put the receptacle or container on the floor, perhaps for several reasons. One would be not to soil or damage the purse or handbag. Secondly, a purse or handbag on the floor may be displaced under the table or desk or a chair and get lost or be forgotten. Still further, a floorborne purse or handbag is vulnerable to theft.

A purse holder of this type must be sufficiently small in size that it is not cumbersome or heavy, this feature also involving the materials of the device is made. It would be best if such device were small enough to be received inside a handbag, when desired and, further, have means for attachment to a strap or one of the straps of a purse or handbag when it is desired to be carried externally.

Optimally, such a purse holder would be so constructed as to be able to receive the strap or straps of more than one handbag (so that a friend's handbag can also perhaps be suspended from the same holder) and further have versatility with respect to how the purse or handbag is hung with respect to the supporting table, desk or the like. Thus, the bag should be optionally suspendable at right angles to the supporting edge of the desk or tables.

Another place where a handbag or purse may be held, in absence of a device of this type, is in the lap of a person or lady. While setting the handbag or purse on the table or in one's lap may be safer, etc., than putting it on the floor, both of these places for storage are often essentially impractical and often uncomfortable, at least in the lap position. The device should keep the handbag or purse within sight and easy reach when one or a lady is seated at a table or desk.

Applicant notes the following U.S. patents and foreign published patent applications:

Inventor John P. Semcer; U.S. Pat. No. 4,728,069; “Article Attachment For Bars, Tables And The Like”; issued Mar. 1, 1988.

Inventor Samuel S. Kennedy; U.S. Pat. No. 4,978,093; “Purse Hanger”; issued Dec. 18, 1990.

Inventor Kenny D. Creed; U.S. Pat. No. 5,094,417; “Handbag Adaptable Support”; issued Mar. 10, 1992.

Inventor Allen K. W. Lo; U.S. Pat. No. 5,594,419; “Table-Edge Hanger”; issued Jan. 14, 1997.

Applicant Mario Blanchini; European Patent Application No. 91830359.5; “Spring Clip Device for the Hanging Handbags and the Like from the Edge of a Table”, filed Aug. 28, 1991.

Applicant and Inventor Allen Lo et al.; International Application No. PCT/US97/00343; “Table-Edge Hanger”; filed Jan. 8, 1997.

### BRIEF DESCRIPTION OF THE DRAWINGS

In the drawings, which form a part of the instant specification and are to be read in conjunction therewith, illustrative embodiments of the inventions are shown and, in the various views, like numerals are used to indicate like parts:

FIG. 1 is a perspective view of this invention showing how the holding device suspends an item such as a pocketbook, a briefcase or the like with respect to a support; and

FIGS. 2A and B illustrate respectively a side view of the holding device as shown in FIG. 1 and a front view of the device as shown in FIG. 1.

### DESCRIPTION OF A PREFERRED EMBODIMENT OF THIS INVENTION

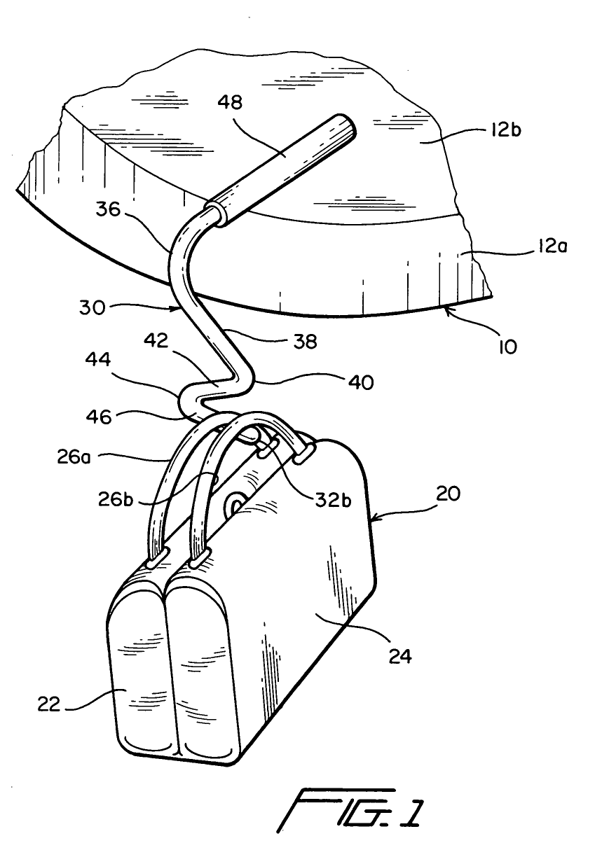

Referring now to the drawings and in particular to FIG. 1, there is shown a holding device or hook, which is identified by the numeral 30 and serves to suspend an object, which in one illustrative embodiment of this invention may take the form of a purse, a handbag, a briefcase, a shopping bag or the like, which is identified by the numeral 20. The object 20 includes an end portion 22, an elongated side portion 24, and a pair of straps 26A and 26B, which are connected to the top of the object 20. The holding device 30 provides a means or mechanism for engaging and supporting the object 20 by its straps 26A and 26B from a support 10. As would be appreciated by one skilled in the art, the support 10 may take the form of a table, a desk, a shelf or the like. The support 10 includes an edge 12a and an upper or support surface 12b. As shown in FIG. 1, the holding device 30 engages the support surface 12b, whereby the object 20 is suspended therefrom.

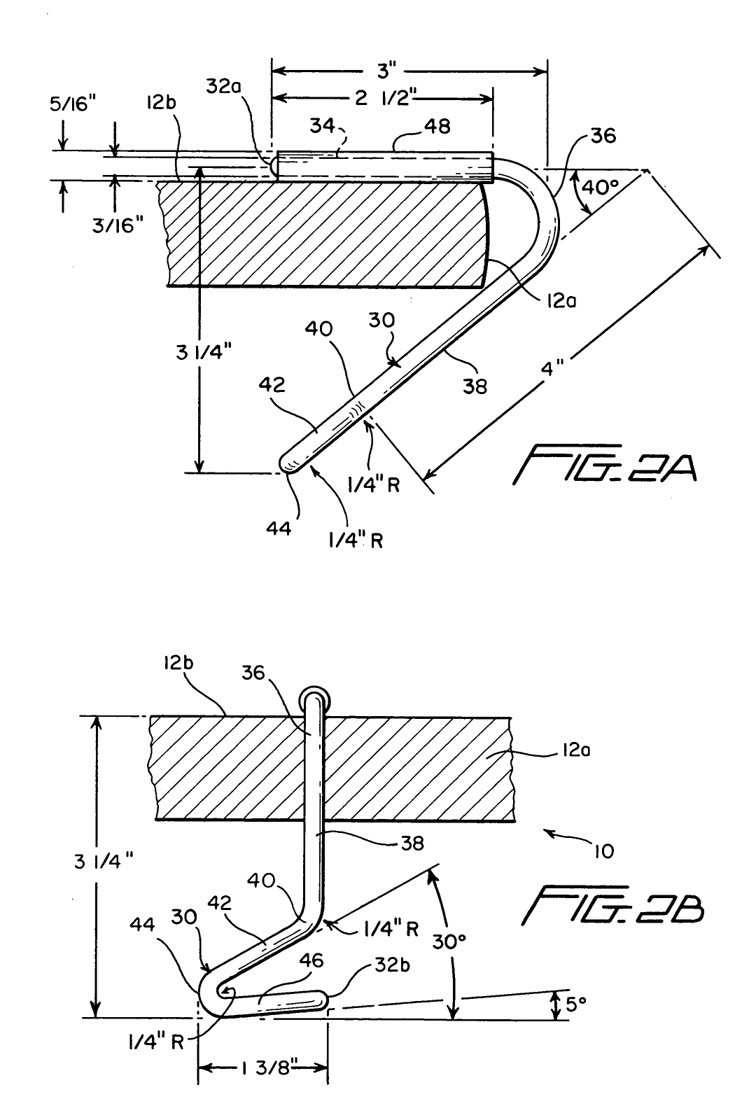

Referring now to FIGS. 1, 2A and 2B, the holding device 30 is illustratively shown as made of a single, unitary rod. In particular, the rod has a first end 32a (see FIG. 2A) and a second end 32b (FIGS. 1 and 2B). The rod from which the holding device 30 is made may be made of a metal such as low carbon steel, a plastic or other materials as would be known to those skilled in this art to provide the resulting holding device 30 with sufficient rigidity so as to support the object 20. Further, the holding device 30 is illustratively formed or manufactured by imparting to the unitary rod a series of bends thereto whereby the holding device 30 as shown in the drawings and described in this document is formed. In an illustrative embodiment of this invention, the holding device 30 is so bent to form an abutting leg 34 (FIG. 2A), an extending leg 38 (FIGS. 1, 2A and 2B), and a hook connected to the extending leg 38. The hook includes a connecting arm 42 (FIGS. 1, 2A and 2B) and a holding arm 46 (FIGS. 1 and 2B). As best illustrated in FIG. 1, the straps 26A and B of the object 20 engage the holding arm 46 and are suspended therefrom to hang the object 20 in a suspending relationship with respect to the support surface 12b (FIG. 1).

In particular, that end of the abutting leg 34 opposite to the first end 32a is connected by a bend 36 to a first end of the extending leg 38 (FIG. 2A). The bend 36 orients the abutting leg 34 at an angle 36′ with respect to the extending leg 38, as best shown in FIG. 2A. A second end of the extending leg 38 opposite the first end thereof is connected to the connecting arm 42 by a bend 40. In particular, the bend 40 orients the connecting arm 42 at an angle 40′ with respect to the extending leg 38, as best shown in FIG. 2B. A second end of the extending leg 38 is connected by the bend 44 to a first end of the holding arm 46 opposite to the second end 32b, as best shown in FIG. 2B. The connecting arm 42 is oriented by the bend 44 at an angle 44′ to the holding arm 46. As best shown in FIGS. 2A and B, the connecting arm 42 and the holding arm 46 are in one illustrative embodiment of this invention disposed within a common plane in which the connecting 42, the holding arm 46 and the extending leg 38 lie.

As best shown in FIG. 2A, a high friction material is attached to the abutting leg 34, whereby when the holding device 30 is mounted upon the support surface 12b (FIG. 1) and, in particular, its abutting leg 34 rests on the support or top surface 12b, that the tendency of the abutting leg 34 to slip with respect to the support surface 12b, is reduced by the high coefficient material 34. In an illustrative embodiment of this invention, the high coefficient material may take the form of a holding sleeve 48. The holding sleeve 48 is made of the high friction material, which, in an illustrative embodiment of this invention, may be made of a rubber material such as pure gum rubber, or other high friction material as would be recognized by one skilled in the art.

As best shown in FIG. 2B, there is provided a reference line 49′, which lies within the plane along with the holding arm 46, the connecting arm 42 and the extending leg 38. Appreciating that when holding device 30 is mounted on the support 10 (FIG. 1), an axis of the extending leg 38 under the influence of gravity will intercept the horizontal reference line 49′ at a right or 90 degree angle. The holding arm 46 is disposed at an angle 46′ with respect to the horizontally disposed reference line 49′. In addition, the holding arm 46 is illustratively oriented at a right or 90 degree angle to the abutting leg 34 (FIG. 2A), whereby the object 20 will be suspended by the holding device 30 in a manner that will tend to prevent the straps 26A and 26B from sliding or being pushed off accidentally from the holding arm 46.

As best shown in FIG. 2A, there is illustratively shown that the extending leg 38 orients the hook formed by the connecting arm 42 and the holding arm 46 in a manner that tends to prevent the abutting leg 34 to slide off or to be pushed off of the support surface 12b of the support 10. In particular, the angle 36′ disposes the extending leg 38 and the hook connected thereto in a position underneath the abutting leg 34 and, in particular, underneath the first end 32a of the holding device 30, whereby the holding device 30 acts as a lever to exert a force created by object 20 and directed downwardly as shown in FIG. 2A at the first end 32 of the abutting leg 34. Further, it is noted that in an illustrative embodiment of this invention that the abutting leg 34 and the extending leg 38 lie within a common plane. In the context of an object 20 hanging vertically with respect to the support surface 12b, the holding arm 46 (see FIG. 2B) is disposed perpendicular to or at an angle of 90 degrees with respect to the abutting leg 34. Thus, the object 20 is suspended in a manner that tends to exert the highest amount of force at the first end 32A of the object 20, thereby increasing the friction between the holding sleeve 34 and the support surface 12b. Further, the orientation of the extending leg 38 tends to orient the object 20, when it is suspended by the holding device 30, in a position that will be underneath the support 10 and thus minimize accidental hitting of the object 20.

In an illustrative embodiment of this invention, the angle 36′ (FIG. 2A) is set at 40 degrees, angle 40′ at 120 degrees, angle 44′ at 30 degrees and angle 49′ at 5 degrees. It is appreciated that one skilled in the art could adjust these angles without changing the desired orientation of the object 20 with respect to support 10, or creating the desired force on the first end 32a of the holding device 30.

In an illustrative embodiment of this invention, the holding sleeve 48 is made of a rubber, plastic or light material that will facilitate gripping the support surface 12b and will prevent damage thereto. The holding device 30 is formed of a unitary rod, which is made of a particular material and diameter that will impart sufficient strength to support a heavy object 20, but be sufficiently lightweight and of compact dimension to permit the holding device 30 to be conveniently portable, i.e., to be readily carried with the person. Further, the holding arm 46 is disposed substantially perpendicular to or at a 90 degree angle to the abutting leg 34, whereby the object 20, when hung, is disposed so that the long dimension of the side 24 of the object 20 is disposed perpendicular to the edge 12a, when the edge 12a is linear or to the tangent of the edge 12a, when it is circular, whereby the suspended object 20 is disposed generally beneath the support 10 and in an orientation to the support surface 10, whereby the object 20 does not interfere with other people who are sitting or otherwise disposed at the support surface 12b.

In an illustrative embodiment of this invention, the length of the holding arm 46 may be set at 1⅜ inches, which is sufficient to hang or to suspend the object 20 in the form of a handbag, shopping bag or the like and to reduce the tendency for the object 20 from sliding off the holding arm 46. Further, in an illustrative embodiment of this invention, the angle 46′ is set to be 5 degrees, which also aids in attaching the object 20 and to prevent it from falling off of the holding device 30. In a further illustrative embodiment of this invention, the angle 44′ is illustratively set at 30 degrees, whereby an opening is formed between the holding arm 46 and the connecting arm 42 to facilitate disposing the straps 26a and 26b therethrough and onto the holding arm 46. In a still further illustrative embodiment of this invention, the dimension between the abutting leg 34 and the holding arm 46 as best shown in FIGS. 2A and 2B is illustratively set at 3¼ inches, the radius of curvature of the bend 36 is set at 1/2 inch and the angle 36′ set at 40 degrees to permit the hanging device 30 to be sufficiently frictionally engaged with most support surfaces 10 as may take the form of a table, desk or the like. In a still further illustrative embodiment of this invention, the bend 44 is made of a radius of curvature of 1/4 inch to establish a 1⅜ inch length of the holding arm 46, whereby the object 20 will tend not to fall from the holding device 30. In another illustrative embodiment of this invention, the abutting leg 34 is made of a length of 2½ inches, which permits the hanging device 30 to obtain a firm yet unobtrusive hold on the support surface 12b. Further, the dimension of the holding device 30 from the first end 32a to the curvature of the bend 36 (FIG. 2A), the radius of the curvature of the bend 36, and the angle 36′ are respectively set in an illustrative embodiment of this invention at 3 inches, 1/2 inch and 40 degrees, whereby the holding device 30 secures a firm hold to the support surface 12b (FIG. 1). In a further illustrative embodiment of this invention, the dimension of the holding device 30 from the bend 40 along the length of the extending leg 38 to the point where the extended axis of the leg 38 intersects with the extended axis of the abutting leg 34, is selectively chosen as 4 inches, which places the holding arm 46 in a position below the abutting leg 34 and, in particular, the first end 32a (as best shown in FIG. 2A) and allows the force of gravity as exerted by the suspended object 20 to exert a force by the attaching leg 34 and the first end 32a on the support surface 12b, whereby the holding sleeve 36 is forced against the support surface 12b to thereby increase the degree of friction therebetween and to prevent the holding device 30 from accidentally sliding or falling off the support 10. The curvature of radius at bend 44 (FIG. 2B) and at bend 36 (FIG. 2A) prevents the forming of sharp points that might otherwise injure a user. In a still further illustrative embodiment of this invention, the radius of curvature of the bend 36 is set at 1/2 inch, while the dimension between the abutting leg 34 and the holding arm 46 is set illustratively at 3¼ inches and the radius of curvature of the bend 40 (FIG. 2A) is set at 1½ inches, to permit the holding device 20 to be used with a support 10 of varying configuration and dimension.

From the foregoing, it will be seen that this invention is well adapted to teach all of the ends and objects hereinabove set forth together with other advantages which are obvious and which are inherent to the apparatus.

It will be understood that certain features and subcombinations are of independent utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

I claim:

1. A device for suspending an object from the surface of a support, said device comprising:
(a) a first leg adapted to abut the support surface, said first leg having first and second ends;
(b) a second leg having first and second ends, said first end of said second leg being connected to said second end of said first leg so that said first leg is oriented at an angle with respect to the said first leg; and
(c) a hook connected to said second end of said extending leg, said hook being adapted to be releasably attached to the object and, when said first leg is disposed on said support surface, said hook lies beneath said first leg and said first end, so that the weight of the object exerts a force on said first end toward said support surface.

2. The device as claimed in claim 1, wherein there is further included a high coefficient material attached to said first leg, thereby preventing the movement of said first leg and said support surface with respect to each other.

3. The device as claimed in claim 2, wherein said material comprises a sleeve that is disposed about said first leg.

4. The device as claimed in claim 1, wherein said hook comprises a third leg having first and second ends, said first end of said third leg being connected to said second end of said second leg, and a fourth leg having first and second ends, said first end of said fourth leg being connected to said second end of said third leg.

5. The device as claimed in claim 4, wherein said third leg is disposed at an angle with respect to said fourth leg to permit the object to be readily disposed with respect to said hook.

6. The device as claimed in claim 1, wherein the object may take the form of a pocketbook, a handbag, a brief, a shopping bag or the like.

7. The device as claimed in claim 1, wherein the device is made of a single, unitary rod, which is appropriately bent to form said first and second legs.
